(19) United States
(12) Patent Application Publication
(10) Pub. No.: US 2009/0079695 A1
(43) Pub. Date: Mar. 26, 2009

(54) INPUT DEVICE

(75) Inventors: Naoki Tatehata, Kyoto (JP); Teruyuki Kimata, Tokyo (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/235,920

(22) Filed: Sep. 23, 2008

(30) Foreign Application Priority Data
Sep. 26, 2007 (JP) 2007-248607

(51) Int. Cl. G06F 3/02

(52) U.S. Cl. 345/168

(57) ABSTRACT

A dial is displayed in display unit showing a plurality of menus, and a control unit connected to an operation unit and the display unit rotates the dial in response to the move of a finger on the operation unit, and thereby a desired menu is selected, and when selecting the menu shown in the display unit, while the finger is touching the operation unit, the dial is rotated by observing the display unit, so that the menu can be selected. Hence, it is not necessary to observe visually the operating position of the operation unit every time, and the input device capable of controlling various operations of an appliance by a simple manipulation can be obtained.

### FIELD OF THE INVENTION

The present invention relates to an input device used mainly in manipulation of various electronic appliances.

### BACKGROUND ART

Recently, in the trend of advancement of functions in various electronic appliances such as a portable telephone and a music player, there is an increasing demand for easy and varied operations in the input device for manipulating them.

Such a conventional input device is explained below by referring to an example of portable telephone shown in FIG. 12.

FIG. 12 is a front view of a conventional input device. The diagram shows box-like movable casing 1 made of insulating resin, and display unit 2 such as liquid crystal display device and so on is provided at the front side of movable casing 1. Display unit 2 is provided with cursor 3, and a plurality of menus 4 showing tune names of music or the like.

Box-like fixed casing 5 made of insulating resin is also shown, and the front side of fixed casing 5 is provided with operation part 6 made of insulating resin, which is oscillatable in vertical and lateral directions, and a plurality of operation keys 7 are arrayed to as to be pressed down, and operation unit 8 is formed including operation part 6 and operation keys 7.

The inside of fixed casing 5 includes a wiring board (not shown) provided with a plurality of switch contacts (not shown) to be connected and disconnected electrically in response to the operation of operation part 6 or operation keys 7. Control unit 9 is composed of microcomputer and other electronic components, being connected to display unit 2 or operation unit 8, and an input device is composed.

At the linkage of lower end of movable casing 1 and upper end of fixed casing 5, joint part 10 such as hinge mechanism is provided, and movable casing 1 is supported by joint part 10 to open and close on fixed casing 5, and thereby a portable telephone is composed.

In this configuration, when movable casing 1 is opened, and cursor 3 and plurality of menus 4 are displayed in display unit 2, for example, the upper end of operation part 6 is pressed by a finger. When operation part 6 is further oscillated in upward direction, the switch contact disposed beneath operation part 6 is connected or disconnected electrically. This electrical connection or disconnection is detected by control unit 9, and plurality of menus 4 are scrolled upward, and the menu in cursor 3 changes from “03 . . . ” to “04 . . . ”, “05 . . . ” sequentially.

When a desired menu is selected and this menu comes to a position within cursor 3, the center of operation part 6 or specified operation key 7 is pressed, and this menu is decided.

Once releasing the finger, when the lower end of operation part 6 is pressed and operation part 6 is oscillated downward, contrary to the explanation above, the plurality of menus 4 are scrolled downward, and the menus in cursor 3 are changed, and other desired menu can be selected.

That is, by pressing the upper end or lower end of operation part 6, and oscillating operation part 6 in upward direction or downward direction, the plurality of menus 4 can be scrolled upward or downward. As a result, the menus in cursor 3 can be moved, and a desired menu can be selected.

A prior art relating to the invention of the present application is disclosed, for example, in Unexamined Japanese Patent Publication no. 2003-123596.

In the conventional input device, however, when selecting from plurality of menus 4 displayed in display unit 2, the pressing point at the upper end or lower end of operation part 6 is checked visually every time, and operation part 6 is oscillated upward or downward. Thus, menus 4 are scrolled up and down, and the operation is complicated when the number of menus 4 is increased, or scrolling errors such as more scrolling than desired are likely to occur.

### SUMMARY OF THE INVENTION

The present invention is devised to solve the problems of the conventional art, and it is hence an object thereof to present an input device capable of selecting various operations of an appliance by a simple manipulation.

To achieve the object, the present invention has the following configuration.

The input device of the present invention is designed to select menus by displaying a dial in a display unit showing a plurality of menus, and rotating the dial according to the move of the finger on the operation unit by a control unit connected to the operation unit and the display unit. Therefore, when selecting the menu displayed in the display unit, the dial is rotated while touching the operation unit by a finger and observing the display unit, and a desired menu can be selected. It is hence not necessary to check the operating position of the operation unit visually every time, and this input device can select from various operations of an appliance by a simple manipulation.

The present invention therefore realizes an input device capable of selecting from various operations of an appliance by a simple manipulation.

### BRIEF DESCRIPTION OF DRAWINGS

FIG. 1 is a front view of an input device in a referred embodiment of the present invention.

FIG. 2 is a partial sectional view of the input device in the preferred embodiment of the present invention.

FIG. 3A is a partial front view of a display unit of the input device in the preferred embodiment of the present invention.

FIG. 3B is a partial front view of the display unit of the input device in the preferred embodiment of the present invention.

FIG. 3C is a partial front view of the display unit of the input device in the preferred embodiment of the present invention.

FIG. 4A is a partial front view of the display unit of the input device in the preferred embodiment of the present invention.

FIG. 4B is a partial front view of the display unit of the input device in the preferred embodiment of the present invention.

FIG. 5A is a partial front view of an operation unit of the input device in the preferred embodiment of the present invention.

FIG. 5B is a partial front view of the operation unit of the input device in the preferred embodiment of the present invention.

FIG. 5C is a partial front view of the operation unit of the input device in the preferred embodiment of the present invention.

FIG. 6A is a partial front view of the operation unit of the input device in the preferred embodiment of the present invention.

FIG. 6B is a partial front view of the operation unit of the input device in the preferred embodiment of the present invention.

FIG. 6C is a partial front view of the operation unit of the input device in the preferred embodiment of the present invention.

FIG. 7A is a partial front view of a display unit of the input device in the preferred embodiment of the present invention.

FIG. 7B is a partial front view of the display unit of the input device in the preferred embodiment of the present invention.

FIG. 8A is a partial front view of the display unit of the input device in the preferred embodiment of the present invention.

FIG. 8B is a partial front view of the display unit of the input device in the preferred embodiment of the present invention.

FIG. 9A is a partial front view of a dial of the input device in the preferred embodiment of the present invention.

FIG. 9B is a partial front view of the dial of the input device in the preferred embodiment of the present invention.

FIG. 9C is a partial front view of the dial of the input device in the preferred embodiment of the present invention.

FIG. 9D is a partial front view of the dial of the input device in the preferred embodiment of the present invention.

FIG. 10A is a partial front view of the dial of the input device in the preferred embodiment of the present invention.

FIG. 10B is a partial front view of the dial of the input device in the preferred embodiment of the present invention.

FIG. 10C is a partial front view of the dial of the input device in the preferred embodiment of the present invention.

FIG. 11 is a partial front view of the display unit of the input device in the preferred embodiment of the present invention.

FIG. 12 is a front view of a conventional input device.

### DETAILED DESCRIPTION OF PREFERRED EMBODIMENTS

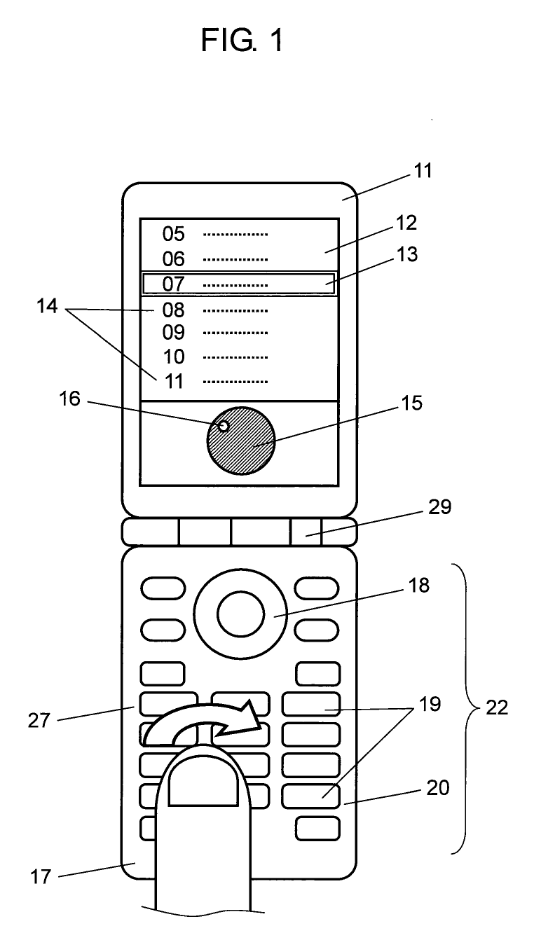

A preferred embodiment of the present invention is described specifically below while mainly referring to an example of a portable telephone shown in FIG. 1 to FIG. 11. In these drawings, the sectional views are magnified in the dimension of the thickness direction for the ease of understanding of the configuration. Same elements are identified with same reference numerals, and the repeated explanations may be omitted where evident.

### Embodiment

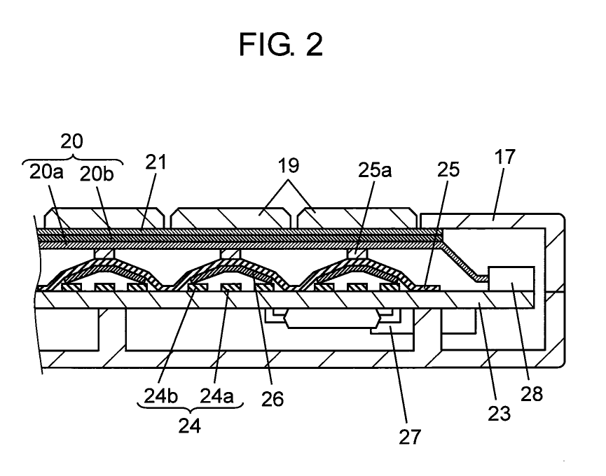

FIG. 1 is a front view of an input device in a referred embodiment of the present invention, and FIG. 2 is its partial sectional view. In FIG. 1, box-like movable casing 11 made of insulating resin is shown, and the front side of movable casing 11 is provided with display unit 12 such as liquid crystal display device and so on. Display unit 12 also shows rectangular cursor 13, and a plurality of menus 14 such as tune names of music or names of registered people.

Display unit 12 is divided into upper and lower halves, and substantially circular dial 15 is shown below menus 14, and circular marker 16 is provided in upper left corner near the outer circumference of dial 15.

The front side of box-like fixed casing 17 made of insulating resin is provided with a plurality of operation keys 19 to be pressed so as to rotate or oscillate operation part 18 made of insulating resin in vertical and lateral directions.

Touch pad 20 is an capacitive sensor touch pad shown in FIG. 2, in which a plurality of band-like conductive layers (not shown) of silver or carbon are arranged orthogonally on the upside of film-like flexible board 20a of polyether sulfone, polycarbonate, or polyethylene terephthalate, by way of insulating layer 20b of polyester or epoxy and so on. Hereinafter, the capacitive sensor touch pad is explained as an example of touch pad 20.

Operation unit 22 shown in FIG. 1 is formed by laminating cover sheet 21 such as rubber or elastomer and capacitive sensor touch pad 20, which are disposed at the downside of plurality of operation keys 19.

On the upside and downside of wiring board 23 of paper phenol, glass contained epoxy or the like, a plurality of wiring patterns (not shown) are formed by copper foils or the like. In addition, the upside of wiring board 23 beneath operation keys 19 shown in FIG. 2 is provided with a plurality of fixed contacts 24 of copper, carbon or the like, formed of circular central fixed contact 24a, and outside fixed contact 24b of horseshoe shape or ring shape surrounding it.

Base sheet 25 is a film made of polyethylene terephthalate, polycarbonate, polyurethane or similar material, and movable contacts 26 are shaped like a dome, and made of copper alloy, steel, or other conductive thin metal plate. The plurality of movable contacts 26 are adhered to the downside of base sheet 25, and the outer circumference of each movable contact 26 is placed on the top of outside fixed contact 24b. Base sheet 25 is adhered and disposed on the upside of wiring board 23 so that the center of the downside of movable contact 26 may be opposite to central fixed contact 24a across a specified gap.

The upside of base sheet 25 above the center of movable contact 26 is provided with protrusion 25a made of polyester, epoxy or the like. In addition, the upside of protrusion 25a contacts with the downside of capacitive sensor touch pad 20 beneath the center of operation keys 19, and a plurality of switch contacts are formed beneath each operation key 19 in the plurality of operation keys 19.

Control unit 27 composed of microcomputer and other electronic components is formed on wiring board 23. Control unit 27 is connected to display unit 12, plurality of fixed contacts 24, and capacitive sensor touch pad 20 having ends of flexible board 20a inserted in connector 28, by way of wiring patterns, and the input device of the present invention is composed.

Further, as shown in FIG. 1, at the linkage of lower end of movable casing 11 and upper end of fixed casing 17, joint part 29 such as hinge mechanism is provided, and movable casing 11 is supported by joint part 29 to open and close on fixed casing 17, and thereby a portable telephone is composed.

In this configuration, movable casing 11 is opened, and for example, when speaking while nothing is displayed on display unit 12, operation key 19 showing a numeral or the like is pressed. As a result, capacitive sensor touch pad 20 is deflected, and the upside center of movable contact 26 at the downside is pressed through protrusion 25a, and a specified pressure is applied. Consequently, movable contact 26 is elastically inverted downward with a click feel, and the downside center of movable contact 26 contacts with central fixed contact 24a, and thereby central fixed contact 24a and outside fixed contact 24b are electrically connected by way of movable contact 26.

This electrical connection or disconnection of fixed contact 24 is detected by control unit 27, and the numeral of pressed operation key 19 is displayed in display unit 12, and by repeating several times, a telephone number is displayed in display unit 12, and it is ready to speak.

By pressing specified operation key 19, when the plurality of menus 14 and dial 15 are displayed in display unit 12 as shown in FIG. 1, operation unit 22 having the plurality of operation keys 19 is touched lightly by finger. As a result, the capacitance changes in the conductive layer of capacitive sensor touch pad 20 near the downside of this touched operation key 19, and from the change in capacitance, the position touched by the finger is operated and detected by control unit 27. In order to detect the correct position, capacitive sensor touch pad 20 is formed of a plurality of band-like conductive layers (not shown) made of silver or carbon arrayed in orthogonal directions.

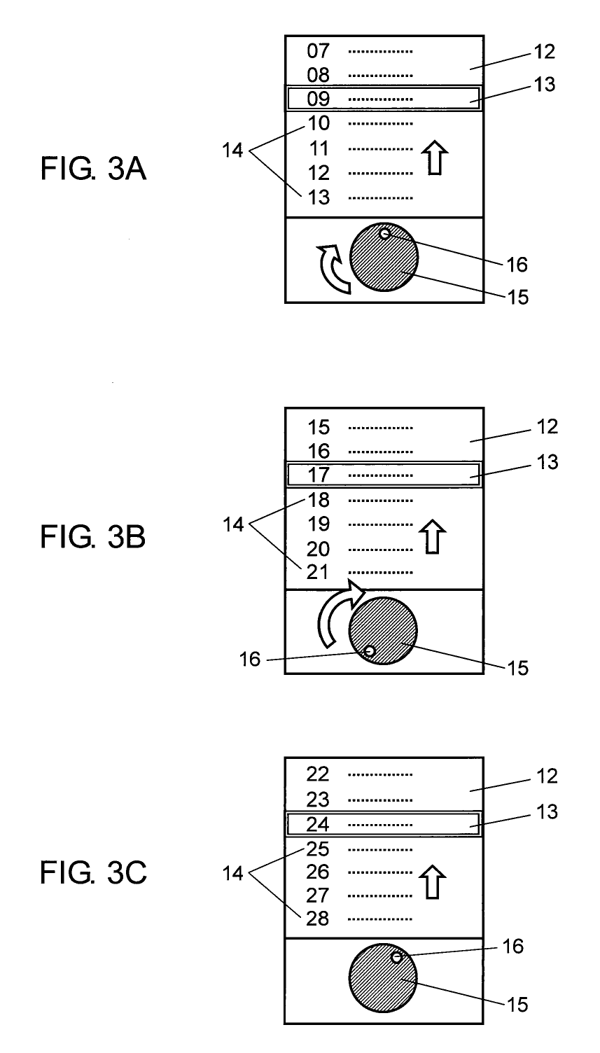

While touching operation unit 22, for example, when the finger is largely moved circularly clockwise, control unit 27 detects the change in the position touched by the finger from change in capacitance of capacitive sensor touch pad 20 same as mentioned above. As shown in a partial front view of display unit 12 in FIG. 3A, when dial 15 is rotated by a specific angle, and the plurality of menus 14 are scrolled upward, the menus in cursor 13 are changed from “07 . . . ” to “08 . . . ”, “09 . . . ” and so forth sequentially.

When the circular motion of the finger continues, similarly, control unit 27 detects the position of operation key 19 touched by the finger. As shown in a partial front view of display unit 12 in FIG. 3B, dial 15 is further rotated, and the plurality of menus 14 are scrolled upward.

When reading a desired menu, for example, when the menu of “24 . . . ” reaches the position in cursor 13 as shown in a partial front view of display unit 12 in FIG. 3C, the finger is removed from operation unit 22, and this menu of “24 . . . ” is selected and decided.

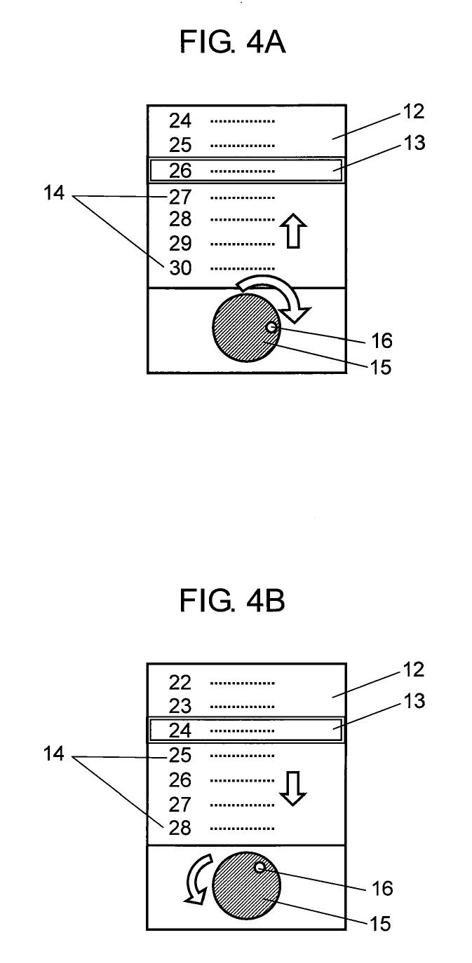

As shown in a partial front view of display unit 12 in FIG. 4A, if menus 14 are scrolled too much upward, and when desired to return slightly downward or when desired to scroll menus 14 downward, the finger is moved circularly counterclockwise. As a result, as shown in a partial front view of display unit 12 in FIG. 4B, control unit 27 detects the change in the operation direction, and rotates dial 15 in counterclockwise direction, and scrolls the plurality of menus 14 downward, so that a desired menu can be selected.

That is, dial 15 is displayed beneath display unit 12 showing the plurality of menus 14. In addition, control unit 27 connected to capacitive sensor touch pad 20 and display unit 12 detects the change of touching position of finger and its moving direction, from the change of capacitance of capacitive sensor touch pad 20 by the move of the finger on operation unit 22. In response to the change of the finger position and moving direction, control unit 27 rotates dial 15, and scrolls the plurality of menus 14 in vertical direction, so that menus 14 may be selected.

Therefore, it is not necessary to check visually every time which one of operation keys 19 of operation unit 22 is touched by the finger. That is, the finger is moved circularly in clockwise direction or counterclockwise direction while touching operation unit 22, and dial 15 beneath display unit 12 can be rotated, and the plurality of menus 14 above can be scrolled. Since menus 14 can be selected while observing the rotation and scrolling, various operations of the appliance can be manipulated easily.

When control unit 27 detects the change in capacitance of capacitive sensor touch pad 20 by the move of the finger, control unit 27 converts and calculates the finger position change and the moving direction as relative position, not absolute position of operation unit 22 actually touched by the finger moving circularly. As a result, dial 15 is rotated, and menus 14 can be selected regardless of the position touched by the finger or the finger moving amount.

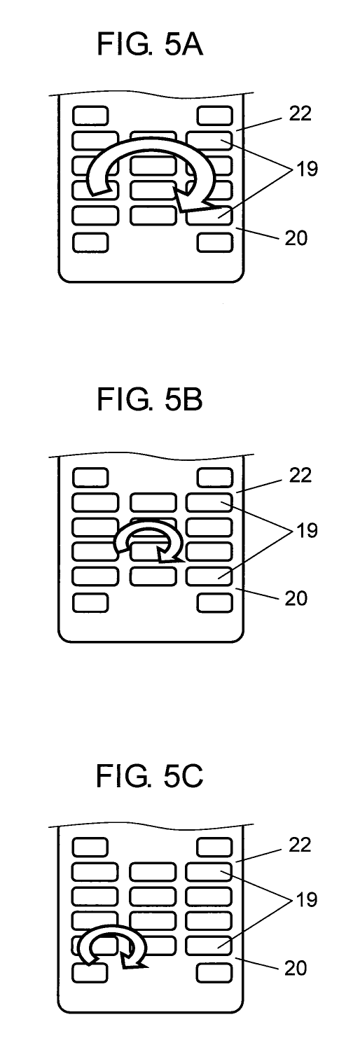

FIG. 5A to FIG. 5C are partial front views of operation unit 22 of the input device of the preferred embodiment of the present invention. FIG. 5A shows the finger is moved clockwise largely around the entire circumference of operation unit 22. FIG. 5B shows the finger is moved in a small circle in the center of operation unit 22. FIG. 5C shows the finger is moved in a small circle at the lower left corner of operation unit 22.

In any case of FIG. 5A to FIG. 5C, by rotating dial 15 similarly, menus 14 can be selected by a small touching operation, and the selection operation of menus 14 is easier.

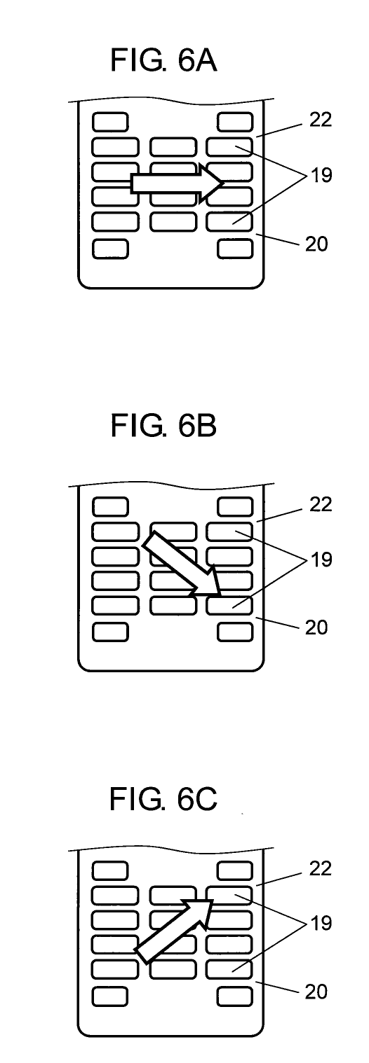

FIG. 6A to FIG. 6C are partial front views of operation unit 22 of the input device of the preferred embodiment of the present invention. Instead of the circular motion of the finger shown in FIG. 5A to FIG. 5C, FIG. 6A shows the finger is moved straightly in right direction from operation unit 22, FIG. 6B shows the finger is moved straightly in lower right direction, and FIG. 6C shows the finger is moved straightly in upper right direction.

In any case of FIG. 6A to FIG. 6C, control unit 27 rotates dial 15 by a specified angle in response to the move of the finger, so that menus 14 can be selected.

Moreover, in response to the moving speed of the finger, control unit 27 controls the display of display unit 12 in various modes, and the plurality of menus 14 can be selected more quickly and easily.

For example, when the finger is moved faster than a certain threshold stored in control unit 27, control unit 27 accelerates the rotating speed of dial 15 and scrolling speed of menus 14, so that the plurality of menus 14 can be selected more quickly.

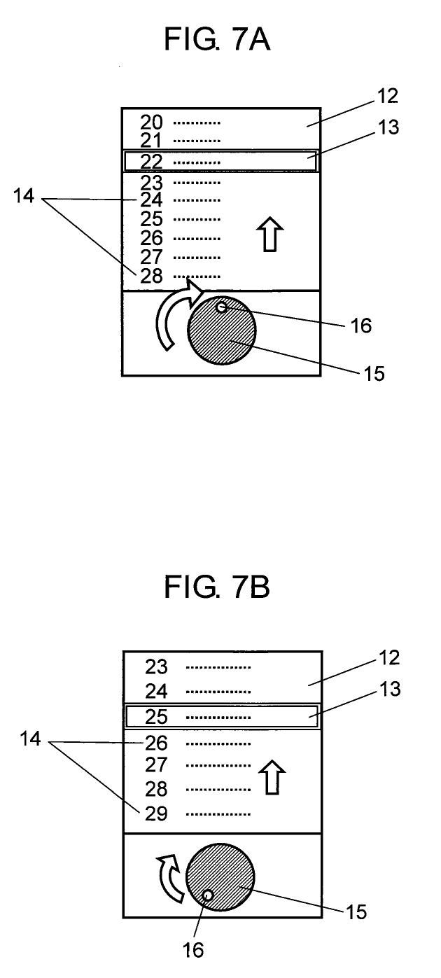

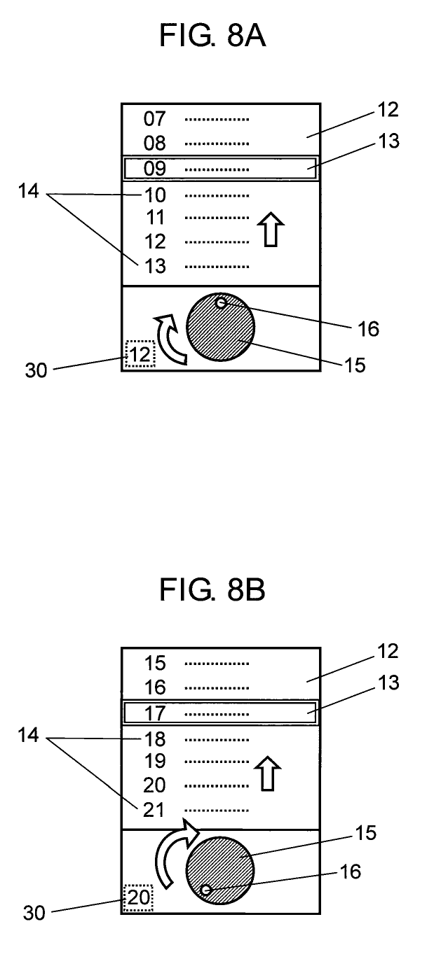

FIG. 7A and FIG. 7B, and FIG. 8A and FIG. 8B are partial front views of display unit 22 of the input device of the preferred embodiment of the present invention.

As shown in FIG. 7A, when the finger moving speed is higher than a certain threshold, the plurality of menus 14 is reduced and displayed, and more menus 14 are displayed in display unit 12. When the finger moving speed becomes slower, as shown in FIG. 7B, menus 14 are returned to original size and displayed.

Further, as shown in FIG. 8A, while dial 15 is turned a full revolution at a specified position at a lower left side of dial 15 of display unit 12, the number of menus 14 scrolled in vertical direction is indicated as numeral 30. At the same time, in response to the moving speed of the finger, the number of menus 14 to be scrolled or the display of numeral 30 may be changed, and the selection operation is much easier and faster.

For example, while dial 15 is turned a full revolution, if 12 menus 14 are scrolled in vertical direction, as far as the finger is moved at ordinary speed, as shown in FIG. 8A, numeral 30 indicates “12” at the lower left corner of dial 15. When the finger moving speed is faster than a certain threshold, as shown in FIG. 8B, numeral 30 is changed to “20”, and 20 menus 14 are scrolled by control unit 27 during a full revolution of dial 15.

When changing the number of menus 14 to be scrolled in full revolution of dial 15, that is, when changing the speed, in response to the moving speed of the finger, the scroll speed can be increased by a magnifying factor of, for example, the power of 1.2 to about 3. However, if the scrolling speed is too fast, the selection operation is difficult, and usually the magnifying factor of the power of 1.5 to about 2 may be preferred. For example, when raised to the power of 1.5, when the move of the finger and the rotation of dial 15 are accelerated two times, menus 14 are scrolled at speed of about 2.8 times.

When rotating dial 15 by touching with the finger and scrolling and selecting menus 14, circular marker 16 is provided near the outer circumference of dial 15. By this marker 16, it is easy to check the rotating position of dial 15 visually, and menus 14 can be selected more easily.

In the explanation above, circular dial 15 is shown in display unit 12, and circular marker 16 is provided near the outer circumference of dial 15.

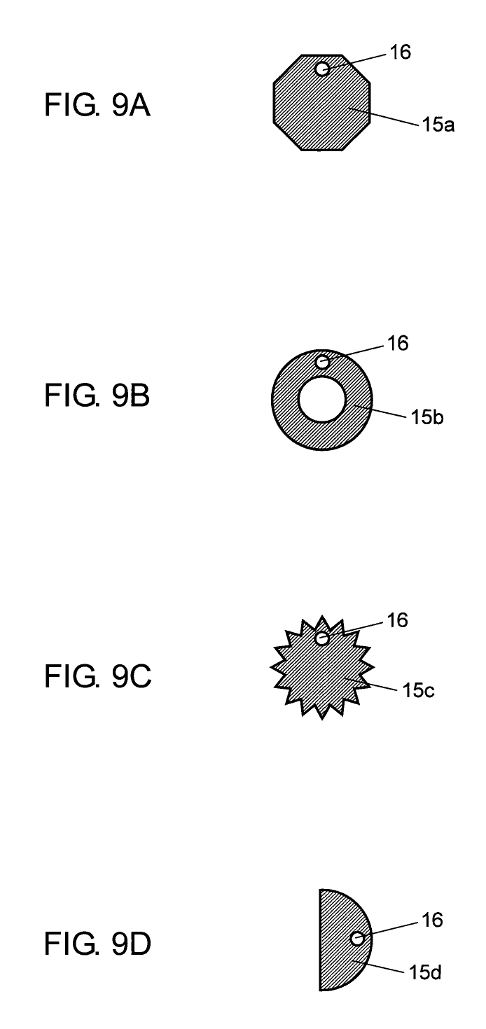

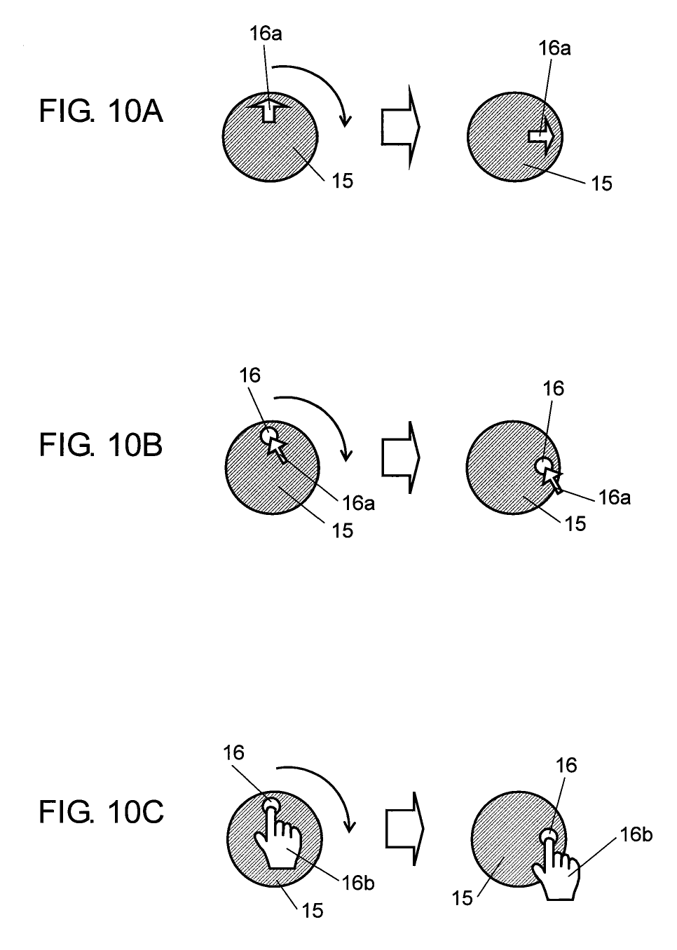

FIG. 9A to FIG. 9D, and FIG. 10A to FIG. 10C are partial front views of dial 15 of the input device of the preferred embodiment of the present invention. FIG. 9A shows dial 15a disposed in a polygonal shape, FIG. 9B shows dial 15b disposed in a ring shape, FIG. 9C shows dial 15c disposed in a convex and concave shape on the outer circumference, and FIG. 9D shows dial 15d disposed in a semicircular shape. By using these dials 15a, 15b, 15c, 15d shown in FIG. 9A to FIG. 9D, the input device of the present invention may be used similarly, these dials may be selected according to the preference of the user or various applications.

Instead of circular marker 16, as shown in FIG. 10A, arrow-like maker 16a may be provided near the outer circumference of dial 15, and dial 15 and arrow-like maker 16a may be rotated simultaneously. Moreover, circular marker 16 and arrow-like marker 16a may be combined as shown in FIG. 10B.

Further, as shown in FIG. 10C, circular marker 16 and finger-like marker 16b may be combined, or these markers may be in a different color from dial 15 so that they may be recognized easily.

Meanwhile, as shown in FIG. 10B or FIG. 10C, when circular marker 16 is combined with arrow-like marker 16a or finger-like marker 16b, circular marker 16 rotates together with dial 15. At this time, as shown in FIG. 10B or FIG. 10C, the direction of arrow-like marker 16a or finger-like marker 16b may not be changed, and thereby dial 15 may be rotated. In this configuration, marker 16a or marker 16b can rotate dial 15 as a virtual finger, and thereby intuitive operational condition can be realized.

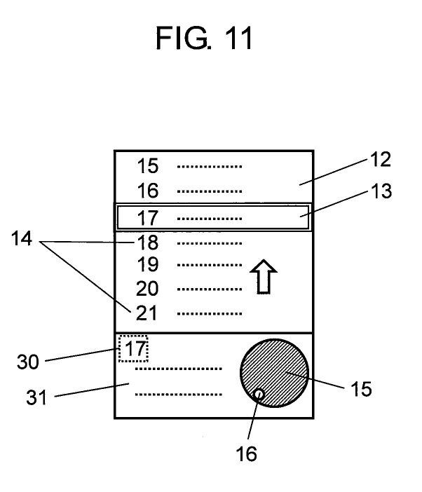

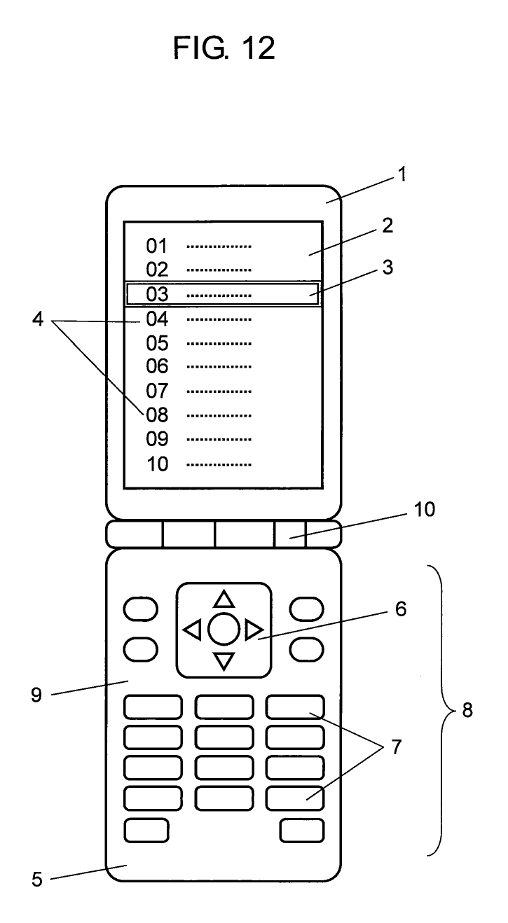

FIG. 11 is a partial front view of display unit of the input device of the preferred embodiment of the present invention. As shown in FIG. 11, dial 15 of display unit 12 may be shifted to the right side. As a result, the left side is open to display, for example, the numerals and contents of menus 14 of cursor 13 shown currently, and when menus 14 are tune names of music, sub-menu 31 such as singer's name or part of verses may be displayed beneath numeral 30. Thus, the input device of easier and versatile operations can be realized.

Thus, according to the preferred embodiment, the input device of the present invention includes display unit 12 showing a plurality of menus 14, operation unit 22 having a plurality of operation keys 19, and control unit 27 connected to operation unit 22 and display unit 12. The input device of the present invention shows dial 15 in display unit 12, and control unit 27 rotates dial 15 in response to the move of the finger on operation unit 22, and selects the menu.

Therefore, when selecting menus 14 shown in display unit 12, dial 15 can be turned while observing display unit 12, keeping the finger on operation unit 22, and menus 14 can be selected. It is hence not necessary to check visually the operating position of operation unit 22 every time, and the input device capable of controlling various operations of the appliance by simple manipulation is realized.

The input device may be also provided with marker 16 at specified position of dial 15. In such configuration, the rotating position of dial 15 may be easily recognized visually by marker 16, and menus 14 may be selected more easily.

The input device of the present invention includes touch pad 20, and a plurality of operation keys 19 arranged on touch pad 20, and when the finger touches operation unit 22, control unit 27 detects the position of operation unit 22 touched by the finger by touch pad 20.

In this configuration, the capacitance changes near the downside of operation key 19 being touched, for example, the conductive layer of touch pad 20 or capacitive sensor touch pad, and by the change in capacitance, control unit 27 calculates and detects the position touched by the finger. As a result, control unit 27 rotates dial 15 in response to the move of the finger on operation unit 22, and selects the menu.

The input device of the present invention is designed to control the menu display of display unit 12 in response to the finger moving speed by control unit 27. In such configuration, for example, when the finger moving speed is fast, the plurality of menus 14 are reduced to display more menus, or the scrolling speed of plurality of menus 14 is accelerated. Hence, the plurality of menus 14 can be displayed and selected more quickly and easily.

The foregoing explanation is about a portable telephone as an example of electronic appliance using the input device of the present invention, but the present invention may be similarly applied to a music player, a remote-control transceiver, a car navigation, and other electronic appliances.

Display unit 12 shows a plurality of menus 14 formed of numerals and character strings of tune names of music or names of registered people, and they are selected by rotation of dial 15. In addition to such configuration, various menus such as maps, program guide, graphics and patterns may be displayed, and selected.

In the foregoing explanation, the plurality of menus 14 are scrolled in vertical direction, and moved into fixed rectangular cursor 13, and the menus are selected. Instead of this configuration, by rotation of dial 15, the cursor or arrow-like or finger-like pointer may be moved, and the menus may be selected, and the same effects of the present invention may be obtained.

What is claimed is:

1. An input device comprising:
a display unit showing a plurality of menus;
an operation unit having a plurality of operation keys; and
a control unit connected to the operation unit and the display unit,
wherein a dial is shown in the display unit, and the control unit rotates the dial in response to move of a finger on the operation unit, and selects the menu.

2. The input device of claim 1, wherein a marker is provided at a specified position of the dial.

3. The input device of claim 1, wherein the operation unit has a touch pad, and a plurality of operation keys disposed on the touch pad, and when the finger touches the operation unit, the control unit detects a position of the operation unit touched by the finger through the touch pad.

4. The input device of claim 1, wherein the control unit controls the menu display of the display unit in response to a moving speed of the finger.
